(19) United States
(12) Patent Application Publication
(10) Pub. No.: US 2010/0052432 A1
(43) Pub. Date: Mar. 4, 2010

(54) Method and Arrangement for Harmonic Wave Suppression in AC Voltage-Operated PTC Air Heaters

(76) Inventors: Klaus SEIDLER, Uetersen (DE); Joerg Engelhardt, Hamburg (DE); Lennard Janiak, Hamburg (DE)

Correspondence Address: DUANE MORRIS LLP - NY;PATENT DEPARTMENT, 1540 BROADWAY, NEW YORK, NY, 10036-4086, US

(21) Appl. No.: 12/548,624

(22) Filed: Aug. 27, 2009

(30) Foreign Application Priority Data
Aug. 29, 2008 (DE) 10 2008 045 234.3

(51) Int. Cl. H02M 1/12

(52) U.S. Cl. 307/105

(57) ABSTRACT

The invention is directed to a method and an arrangement for harmonic wave suppression in AC voltage-operated PTC heaters in which a harmonic component which is generated in the current of the PTC heater and which contains predominantly the third harmonic of the heating current is compensated by the superposition of correction signals. It is the object of the invention to find a novel possibility for a simple and robust suppression of harmonic waves in AC voltage-operated PTC heaters in which the permissible limiting values for harmonic distortion are not exceeded as a result of changes in heating output. This object is met according to the invention in that a voltage modulation is generated in a voltage modulator (4) arranged in series with the PTC heater (3), wherein a defined partial amplitude attenuation of the sinusoidal supply voltage (U₁) is carried out as voltage modulation for suppressing the third harmonic in the heating current (I₂) of the PTC heater (3).

### FIELD OF THE INVENTION

The invention is directed to a method and an arrangement for harmonic wave suppression in AC voltage-operated PTC heaters in which a harmonic component which is generated in the current of the PTC heater and which contains predominantly the third harmonic of the heating current is compensated by the superposition of correction signals, particularly for PTC heating elements in frequency-stable and frequency-variable AC voltage networks in aeronautic and aerospace vehicles.

### BACKGROUND

PTC heaters have a temperature-dependent resistance coefficient and a voltage-dependent resistance coefficient. Whereas the temperature-dependent coefficient presents the desired function, the voltage-dependent behavior is a negative secondary effect for the application and, with a sinusoidal supply voltage, results in current harmonics and, therefore, in an undesirable harmonic distortion factor. In most PTC heaters, the odd-numbered harmonics contribute the greatest proportion with a typical total harmonic distortion of greater than 7%. In special applications such as heaters for aircraft and spacecraft, for example, the permissible distortion factors are limited and may not exceed 5%, for example. Therefore, when PTC heaters are used in special applications, it is necessary to resort to filters so as not to exceed the permissible limiting values for harmonic distortion.

It is known in the art to suppress undesirably high harmonic components by means of passive LC filters or active inverter circuits. However, particularly in frequency-variable power supplies, this results in a cumbersome circuit with regard to weight, volume, and cost.

### PRIOR ART

U.S. Pat. No. 5,751,138 describes a circuit for the compensation of harmonic wave interference in a line voltage system in which a pulse width modulated inverter for each phase is controlled to produce a harmonics compensation signal that is coupled to an inductor coil. The inductor coil is arranged in series between a square-wave inverter and a respective phase. The square-wave inverter generates a current which compensates in opposed phase for the reactance of the load in the respective phase of the current path. In so doing, the square-wave inverter is decoupled from the pulse width modulated inverter and operates at a frequency which substantially exceeds the fundamental frequency so that the voltage supply by itself represents an unwarrantably high expenditure.

In a solution for reducing cost which is known from DE 10 2007 012 699 A1, the dominating third harmonic is substantially compensated by a parallel-injected current with a 180-degree phase rotation. However, it proves disadvantageous that the third harmonic can be ideally regulated to zero only for a selected operating point, preferably in the high-load range of the heater, whereas an overcompensation results in all of the low-load levels resulting again in the third harmonic, this time in the opposite phase. Further, the current modulation is carried out at three-times the frequency of the supply voltage, which leads to an increased susceptibility to interference, e.g., in aircraft power supplies, in case of fluctuations in the supply voltage.

### OBJECTS OF THE INVENTION

It is an object of the invention to find a novel possibility for harmonic wave suppression in AC voltage-operated PTC heaters which provides a simple and robust suppression of harmonics in which changes in voltage due to a change in heating output do not lead to overcompensation or unwanted surpassing of the harmonic distortion limit.

In a method for harmonic wave suppression in AC voltage-operated PTC heaters in which a harmonic component which is generated in the current of the PTC heater and which contains predominantly the third harmonic of the heating current is compensated by the superposition of correction signals, the above-stated object is met according to the invention in that a voltage modulation is generated in a voltage modulator arranged in series with the PTC heater, wherein a defined amplitude attenuation of the sinusoidal supply voltage is carried out as voltage modulation for suppressing the third harmonic in the heating current of the PTC heater.

The voltage modulation for suppressing the third harmonic of the heating current is advantageously modulated by amplitude attenuation in the crest regions of the supply voltage as a distorted heating voltage of the load current circuit. To this end, the voltage modulation of the supply voltage of the load current circuit can be adjusted by changing the attenuation factor of the amplitude attenuation as well as by changing the voltage application point of the amplitude attenuation.

The instantaneous value of the supply voltage of the load current circuit is advisably used to control the defined amplitude attenuation of the heating voltage of the load current circuit. For this purpose, the instantaneous value of the supply voltage of the load current circuit is preferably measured by means of voltage dividers and comparators in a voltage sensor arranged in parallel with an AC voltage source.

In an arrangement for harmonic wave suppression in AC voltage-operated PTC heaters in which a PTC heater is arranged in the load current circuit of an AC voltage source, the above-stated object is further met in that a voltage modulator (amplifier) arranged in series with the PTC heater is provided for defined modulation of the heating voltage, and in that the voltage modulation is adjusted in such a way by defined amplitude attenuation of the heating voltage applied to the PTC heater that the third harmonic of the heating current of the PTC heater is suppressed below a predetermined limiting value.

In order to generate the modulated heating voltage, a voltage sensor connected in parallel with the AC voltage source and means for controlling the voltage application point are advisably arranged in the controllable voltage modulator, and the third harmonic of the heating current of the PTC heater is suppressed below a permissible limiting value based on a voltage measurement resulting from the modulated voltage control of the voltage modulator.

Further, it has proven advantageous that in order to generate the modulated heating voltage, a voltage sensor connected in parallel with the AC voltage source and means for controlling the attenuation factor of the defined amplitude attenuation are arranged in the controllable voltage modulator so that the third harmonic of the heating current of the PTC heater is suppressed below a permissible limiting value based on a voltage measurement resulting from the modulated voltage control of the voltage modulator.

### SUMMARY OF THE INVENTION

The present invention stems from the basic consideration that a current compensation according to the prior art (DE 10 2007 012 699 A1) reliably compensates for the harmonic distortion factor only when the voltage supplied to the PTC heater remains unchanged. However, since adapted current compensation circuits for different heating outputs increases the cost of circuitry enormously, the course pursued by the invention consists in attenuating the dominating third harmonic of the PTC heating current by controlling the voltage in such a way that the sinusoidal supply voltage of the heater is attenuated in the region of the voltage crest. The attenuation of harmonic distortion can then be adjusted by way of the circuitry through the voltage application point and the degree of voltage attenuation. As a result, the occurring heating current is attenuated in the region of the crest value and, accordingly, formation of the third harmonic is strongly suppressed.

By optimizing the attenuation, it is possible not to exceed the permissible limiting values for harmonic components and to keep electric losses low by means of a slight distortion of the sinusoidal supply voltage in the attenuation circuit.

By means of the invention, it is possible to realize a simple and robust suppression of harmonics for AC voltage-operated PTC heaters which also avoids overcompensation resulting from changes in heating output and, therefore, does not exceed harmonic distortion thresholds. The voltage attenuation circuit can be designed in a simple manner and is substantially less sensitive to fluctuations in the supply voltage and is therefore more robust and reliable in limiting harmonic distortion. Further, the output losses in the attenuation circuit are dependent upon the heating output, which simplifies the cooling design.

Therefore, compared to the known current compensation circuit based on the injection of a 180-degree phase-shifted third harmonic, the present invention offers a simple alternative by which the required limiting values for the harmonic component can be maintained even in case of sharply varying heating outputs.

### BRIEF DESCRIPTION OF THE DRAWINGS

The invention will be described in more detail below with reference to embodiment examples and the following drawings in which:

FIG. 1 is a schematic diagram of the circuit arrangement according to the invention; and

FIG. 2 is a current-voltage diagram illustrating the method.

### DESCRIPTION OF THE EMBODIMENTS

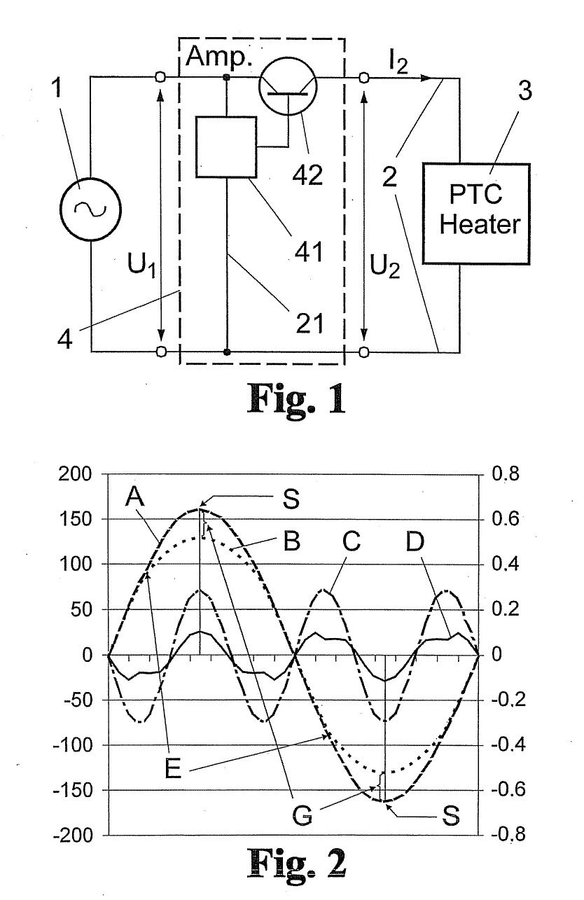

As is shown schematically in FIG. 1, the arrangement for suppressing harmonic interference in PTC heaters in an AC network comprises an AC voltage source 1, a load current circuit 2 in which a PTC heater 3 is arranged, and a control circuit 21 in parallel with the PTC heater 3 which modulates the heating voltage U₂ applied to the PTC heater 3 by means of a voltage modulator 4 in the form of an amplifier.

The circuit shown in FIG. 1 represents an example for implementing a voltage distortion which attenuates a sinusoidal supply voltage U₁ to the PTC heater 3 in the region of the voltage crest S and which therefore brings about an amplitude-attenuated heating voltage U₂ that reduces the third harmonic of the PTC heating current I₂ dominating the total harmonic distortion.

The attenuation is adjusted by way of circuitry by controlling the voltage application point E and the intensity of the voltage attenuation G by means of a voltage sensor 41 containing a comparator followed by a voltage divider. The two adjusting parameters, namely, voltage application point E and voltage attenuation G, are selected and optimized in such a way that the heating current I₂ at the crest value S is so attenuated and, therefore, the formation of the third harmonic so sharply suppressed that the harmonic component at no time exceeds the permissible limiting value (e.g., 5%). The transistor 42 functions as a voltage follower to drive the PTC heater 3 with the distorted heating voltage U₂ generated in the voltage modulator 4 (amplifier module). This is carried out in such a way that the occurring heating current I₂ is attenuated in its crest region and the occurrence of the third harmonic is therefore strongly suppressed.

The physical relationship that is used for this purpose is shown in FIG. 2. In addition to a pure sine function represented as a dashed-line curve A, the graph also shows the phase and amplitude of the ideal supply voltage U₁ represented by the third current harmonic, indicated by the dash-dot curve C, which occurs when the undistorted sine voltage U₁ is applied and which dominates the total harmonic distortion of the PTC heater 3.

The third current harmonic, represented by a solid-line curve D, is appreciably attenuated by a modulated heating voltage U₂ of the PTC heater 3, shown as a dotted curve B, which is attenuated in amplitude but is substantially sinusoidal.

In contrast to the current modulation known from DE 10 2007 012 699 A1, the voltage modulation carried out according to the invention suppresses the third current harmonic of the PTC heater 3 through partial amplitude attenuation. With the exception of the zero crossovers, the third harmonic is at no time actually zero, but can be kept reliably below the given limiting values for the harmonic distortion factor for every heating output of the PTC heater 3.

As can be seen from FIG. 2, the amplitude of the remaining third harmonic of the heating current I₂ (solid-line curve D) that is generated can be adjusted through the choice of the voltage application point E of the attenuation and through the attenuation factor G. The circuit shown in FIG. 1 is adapted to an actual PTC heater 3 in that the voltage attenuation in the voltage modulator 4 is optimized in such a way by varying the adjusting parameters of voltage application point E and attenuation factor G that the harmonic components in the heating current I₂ of the PTC heater 3 are reliably kept below a given permissible limiting value (e.g., 5% in aircraft).

Accordingly, it is possible to generate a heating voltage U₂ that is modulated in a simple manner by means of a voltage-modulated amplifier (voltage follower transistor 42) in series with the PTC heater 3 in the heating circuit 2 in such a way that the generation of the third harmonic of the heating current I₂ is substantially reduced and a reliable suppression (limiting) of the total harmonic distortion is therefore achieved.

### REFERENCE NUMBERS

1 AC voltage source

2 load current circuit

21 control circuit

3 PTC heater

4 voltage modulator (amplifier)

41 voltage sensor

42 (voltage follower) transistor

U₁ (sinusoidal) supply voltage

U₂ (amplitude-modulated) heating voltage

I₂ heating current

A (dashed-line) curve (supply voltage U₁)

B (dotted-line) curve (modulated heating voltage U₂)

C (dash-dot line) curve (third harmonic in 12 with sinusoidal U₁)

D (solid-line) curve (third harmonic in 12 with modulated U₂)

E voltage application point

G attenuation factor

S voltage crest

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A method for harmonic wave suppression in AC voltage-operated PTC heaters in which a harmonic component which is generated in the current of the PTC heater and which contains predominantly the third harmonic of the heating current is compensated by the superposition of correction signals, comprising generating a voltage modulation in a voltage modulator arranged in series with the PTC heater, wherein a defined amplitude attenuation of the sinusoidal supply voltage is carried out as voltage modulation for suppressing the third harmonic in the heating current of the PTC heater.

2. The method according to claim 1, wherein the voltage modulation for suppressing the third harmonic of the heating current is modulated by amplitude attenuation in the regions of the voltage crests of the supply voltage as distorted heating voltage of the load current circuit.

3. The method according to claim 2, wherein the voltage modulation of the supply voltage of the load current circuit is adjusted by changing the attenuation factor of the amplitude attenuation.

4. The method according to claim 2, wherein the voltage modulation of the supply voltage of the load current circuit is adjusted by changing the voltage application point of the amplitude attenuation.

5. The method according to claim 2, wherein the instantaneous value of the supply voltage of the load current circuit is used for defined amplitude attenuation of the heating voltage of the load current circuit.

6. The method according to claim 5, wherein the instantaneous value of the supply voltage of the load current circuit is measured by means of voltage dividers and comparators in a voltage sensor arranged in parallel with an AC voltage source.

7. An arrangement for harmonic wave suppression in AC voltage-operated PTC heaters in which a PTC heater is arranged in the load current circuit of an AC voltage source, comprising a voltage modulator arranged in series with the PTC heater for defined modulation of the heating voltage said voltage modulation being adjusted in such a way by defined amplitude attenuation of the heating voltage applied to the PTC heater so that the third harmonic of the heating current of the PTC heater is suppressed below a predetermined limiting value.

8. The arrangement according to claim 7, wherein a voltage sensor is connected in parallel with the AC voltage source in order to generate the modulated heating voltage, and means for controlling the voltage application point are arranged in the controllable voltage modulator, wherein the third harmonic of the heating current of the PTC heater is suppressed below a permissible limiting value based on a voltage measurement resulting from the modulated voltage control of the voltage modulator.

9. The arrangement according to claim 7, wherein a voltage sensor is connected in parallel with the AC voltage source in order to generate the modulated heating voltage, and means for controlling the attenuation factor are arranged in the controllable voltage modulator, wherein the third harmonic of the heating current of the PTC heater is suppressed below the permissible limiting value based on a voltage measurement resulting from the modulated voltage control of the voltage modulator.
